(19) United States
(12) Patent Application Publication
(10) Pub. No.: US 2026/0278940 A1
(43) Pub. Date: Sep. 17, 2026

(54) METHOD FOR GENERATING 3-DIMENSIONAL MESH BASED ON EQUIRECTANGULAR PROJECTION IMAGE AND COMPUTING DEVICE USING SAME

(71) Applicant: NAVER CORPORATION, Seongnam-si (KR)

(72) Inventors: Gihwan LEE, Seongnam-si (KR); Dongki JUNG, Seongnam-si (KR); Taejae LEE, Seongnam-si (KR); Donghwan LEE, Seongnam-si (KR)

(73) Assignee: NAVER CORPORATION, Seongnam-si (KR)

(21) Appl. No.: 19/681,902

(22) Filed: May 19, 2026

Related U.S. Application Data
(63) Continuation of application No. PCT/KR2024/013621, filed on Sep. 9, 2024.

(30) Foreign Application Priority Data
Nov. 20, 2023 (KR) 10-2023-0160309

(51) Int. Cl. G06T 17/20; G06T 5/77

(52) U.S. Cl. CPC G06T 17/20; G06T 5/77; G06T 2207/20081

(57) ABSTRACT

A method for generating a 3-dimensional mesh based on an equirectangular projection (ERP) image and a computing device using same may include generating a plurality of perspective images by converting an ERP image for a target environment, removing a specific material area via an inpainting technique if a perspective image including the specific material area exists among the plurality of perspective images, generating a depth map and a normal map corresponding to the ERP image by using the plurality of perspective images, and generating a 3-dimensional mesh corresponding to the depth map and the normal map by using a mesh generation model.

### CROSS-REFERENCE TO RELATED APPLICATIONS

This application is a continuation of, and claims the benefit of priority under 35 U.S.C. § § 120 and 365(c) from International Patent Application No. PCT/KR2024/013621 filed on Sep. 9, 2024, in the World Intellectual Property Organization (WIPO), which designates the United States of America and claims priority benefit from Korean Patent Application No. 10-2023-0160309, filed on Nov. 20, 2023, the disclosures of each of which are incorporated herein by reference in their entireties.

### BACKGROUND

Omnidirectional videos may refer to videos or image content captured or played simultaneously in all directions (e.g., 360 degrees). For example, omnidirectional videos may be represented on a three-dimensional spherical surface. Omnidirectional videos may be generated by capturing images or videos regarding a plurality of viewpoints through one or more cameras, respectively, connecting the captured plurality of images to generate a single panoramic image or a spherical image, and then projecting the same onto a 2D picture.

There may be a case where the indoor space is captured as an omnidirectional video, and a three-dimensional model of the indoor space is to be generated based thereon. However, there is a problem in that, if three-dimensional modeling is performed based on an omnidirectional video, severe distortion appears in the omnidirectional video, making it difficult to apply a deep learning model for general depth estimation.

In addition, the indoor space may include mirrors or glass, but the mirrors or glass included in the omnidirectional video cannot be distinguished, and shapes appearing on the mirrors or glasses may thus be reflected in the three-dimensional model. That is, problems such as generation of a three-dimensional model corresponding to a space that does not actually exist may also occur.

### SUMMARY

The disclosure relates to methods for generating a three-dimensional mesh from an equirectangular projection (ERP) image captured using an omnidirectional monocular camera, and/or computing devices using the same.

Some example embodiments of the disclosure may provide methods for generating a three-dimensional mesh based on an ERP image, and/or computing devices using the same, wherein an accurate three-dimensional mesh may be generated from an ERP image captured using an omnidirectional monocular camera.

Some example embodiments of the disclosure may provide methods for generating a three-dimensional mesh based on an ERP image, and/or computing devices using the same, wherein noise or errors on a three-dimensional mesh, which are caused by mirrors or glass included in an ERP image, may be removed.

Some example embodiments of the disclosure may provide methods for generating a three-dimensional mesh based on an ERP image, and/or computing devices using the same, wherein a mesh generation model trained by scheduling respective hyperparameters is utilized.

Some example embodiments of the disclosure may provide methods for generating a three-dimensional mesh based on an ERP image, and/or computing devices using the same, wherein a plane in a generated three-dimensional mesh may be simplified to remove noise.

According to an example embodiment of the disclosure, a method for generating a three-dimensional mesh based on an equirectangular projection (ERP) image using a computing device includes generating a plurality of perspective images by converting an ERP image of a target environment, removing a specific material area from a perspective image using an inpainting technique, if the perspective image including the specific material area exists among the plurality of perspective images, generating a depth map and a normal map corresponding to the ERP image using the plurality of perspective images, and generating a three-dimensional mesh corresponding to the depth map and the normal map using a mesh generation model.

According to an example embodiment of the disclosure, a computing device for generating a three-dimensional mesh based on an equirectangular projection (ERP) image includes a processor configured to generate a plurality of perspective images by converting an ERP image of a target environment, remove a specific material area from a perspective image using an inpainting technique, if the perspective image including the specific material area exists among the plurality of perspective images, generate a depth map and a normal map corresponding to the ERP image using the plurality of perspective view images, and generate a three-dimensional mesh corresponding to the depth map and the normal map using a mesh generation model.

According to an example embodiment of the disclosure, there is provided a non-transitory computer-readable recording medium storing instructions thereon, which when executed by at least one processor, cause a computing device including the at least one processor to implement a method for generating a three-dimensional mesh based on an equirectangular projection (ERP) image, the method comprising generating a plurality of perspective images by converting an ERP image of a target environment, removing a specific material area using an inpainting technique, if a perspective image including the specific material area exists among the plurality of perspective images, generating a depth map and a normal map corresponding to the ERP image using the plurality of perspective images, and generating a three-dimensional mesh corresponding to the depth map and the normal map using a mesh generation model.

In addition, the above-described technical solutions are not intended to list all features of the disclosure. Various features of the disclosure and advantageous effects resulting therefrom will be more fully understood with reference to the following specific example embodiments.

Methods for generating a three-dimensional mesh based on an ERP image and/or computing devices using the same, according to some example embodiments of the disclosure, can remove noise or errors on a three-dimensional mesh caused by mirrors or glass included in the ERP image, thereby generating an accurate three-dimensional mesh regarding the target environment.

Methods for generating a three-dimensional mesh based on an ERP image and/or computing devices using the same, according to some example embodiments of the disclosure, can train a mesh generation model by scheduling respective hyperparameters, thereby implementing a mesh generation model capable of generating a higher-performance three-dimensional mesh without finding optimal hyperparameters.

Methods for generating a three-dimensional mesh based on an ERP image and/or computing devices using the same, according to some example embodiments of the disclosure, can postprocess a generated three-dimensional mesh to remove noise from the three-dimensional mesh and simplify planes, thereby providing a high-quality three-dimensional mesh.

However, advantageous effects that may be achieved by the methods for generating a three-dimensional mesh based on an ERP image and the computing devices using the same, according to example embodiments of the disclosure, are not limited to those mentioned above, and other advantageous effects not mentioned herein will be clearly understood by those skilled in the art to which the disclosure pertains from the following description.

### BRIEF DESCRIPTION OF THE DRAWINGS

FIG. 1 is a diagram illustrating an example of generating an equirectangular projection (ERP) image using an omnidirectional monocular camera according to an example embodiment of the disclosure.

FIG. 2 is a schematic diagram illustrating a three-dimensional mesh generator according to an example embodiment of the disclosure.

FIGS. 3A and 3B are diagrams illustrating an example of an ERP image and an example of a cubemap image according to an example embodiment of the disclosure.

FIGS. 4A and 4B are diagrams illustrating an example of a perspective image and an example of a masking image according to an example embodiment of the disclosure.

FIGS. 5A, 5B, and 5C are schematic diagrams illustrating inpainting regarding a masking area according to an example embodiment of the disclosure.

FIG. 6 is a diagram illustrating an example of projecting points located within a configured range from a plane onto the plane according to an example embodiment of the disclosure.

FIG. 7 is a block diagram illustrating a computing device according to an example embodiment of the disclosure.

FIG. 8 and FIG. 9 are flowcharts illustrating a method for generating a three-dimensional mesh based on an ERP image according to an example embodiment of the disclosure.

### DETAILED DESCRIPTION

Hereinafter, some example embodiments disclosed in this specification will be described in detail with reference to the attached drawings, but the same or similar components will be assigned the same reference numerals regardless of the drawing symbols, and redundant descriptions thereof will be omitted. The suffixes “module” and “unit” used for the components in the following description are assigned or used interchangeably only in consideration of ease of drafting the specification, and do not have distinct meanings or functions by themselves. That is, the term “unit” used in the disclosure indicates a software or hardware component, such as an FPGA or ASIC, and “unit” performs a specific role. However, the “unit” is not intended to be limited to software or hardware. The “unit” may be configured to be in an addressable storage medium or may be configured to reproduce one or more processors. Therefore, for example, “unit” may include components such as software components, object-oriented software components, class components, and task components, processes, functions, properties, procedures, subroutines, segments of program code, drivers, firmware, microcode, circuits, data, databases, data structures, tables, arrays, and variables. The functions provided in the components and “units” may be combined into fewer components and “units” or further separated into additional components and “units.”

As used herein, expressions such as “one of,” “one or more of,” “any one of,” “at least one of,” “at least one among,” and “at least one selected from” when preceding a list of elements, modify the entire list of elements and do not modify the individual elements of the list. Thus, for example, both “at least one of A, B, or C” and “at least one of A, B, and C” mean either A, B, C, or any combination thereof. Likewise, A and/or B means A, B, or A and B.

In addition, if a detailed description of a related known technology is considered to obscure the subject matter disclosed in this specification in connection with describing some example embodiments disclosed in this specification, the detailed description will be omitted. In addition, the attached drawings are only for the purpose of easily understanding the example embodiments disclosed in this specification, and the technical idea disclosed in this specification is not limited by the attached drawings, and it should be understood that all changes, equivalents, or substitutions included in the spirit and technical scope of the disclosure are included therein.

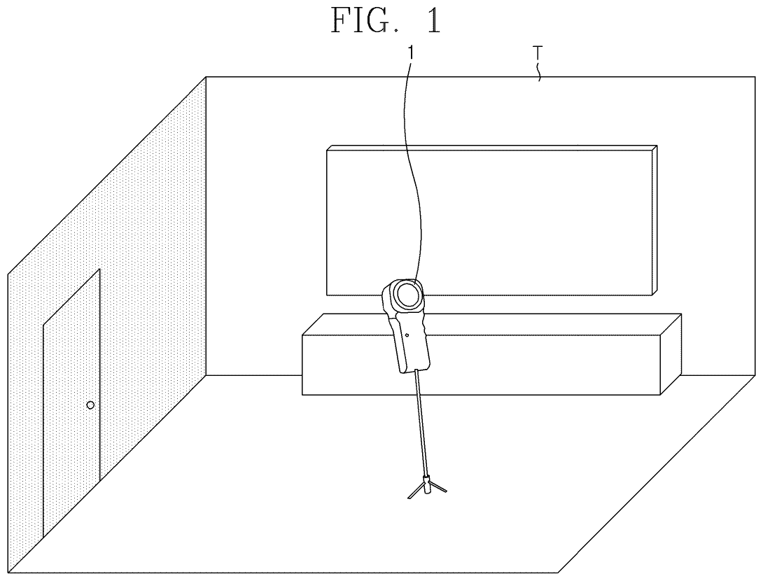

FIG. 1 is a diagram illustrating an example of generating an equirectangular projection (ERP) image using an omnidirectional monocular camera according to an example embodiment of the disclosure. An ERP image is the standard raw format used to store a spherical view as a flat rectangular file.

Referring to FIG. 1, the ERP image may be a photograph taken using an omnidirectional monocular camera 1. In some example embodiments, it is also possible to utilize an image captured from a video taken using the omnidirectional monocular camera 1 as an ERP image. The omnidirectional monocular camera 1 may also generate and provide information about the camera height when capturing the ERP image.

The target environment T captured using the omnidirectional monocular camera 1 may be a specific object or a space, and in some example embodiments, it is also possible to use the indoor space of a building as the target environment T in order to utilize the same for real estate transactions or the like.

The omnidirectional monocular camera 1 may be configured as a single unit, but may also be implemented by coupling the same to various terminal devices such as a smartphone, a tablet PC, a personal digital assistant (PDA), a laptop computer, a wearable device, etc., depending on example embodiments. That is, ERP images regarding the target environment T may be generated using the omnidirectional monocular camera 1 equipped in a smartphone or the like.

Afterwards, the user may transmit the captured ERP image to a three-dimensional mesh generator through a wired/wireless network, thereby requesting the three-dimensional mesh generator to generate a three-dimensional mesh corresponding to the captured ERP image. That is, in order to generate a three-dimensional model corresponding to the target environment based on the three-dimensional mesh, the three-dimensional mesh generator may be requested to generate a three-dimensional mesh.

The user may access the network using his/her terminal device and may communicate with the three-dimensional mesh generator through the network. That is, the user may transmit an ERP image or the like captured by the omnidirectional monocular camera 1 to the three-dimensional mesh generator using the terminal device, and the three-dimensional mesh generator may generate a three-dimensional mesh regarding the target environment, based on the received ERP image. Thereafter, it is also possible to generate a three-dimensional model regarding the target environment, based on the three-dimensional mesh.

The scheme of communication between the terminal device and the three-dimensional mesh generator is not limited, and may include not only a communication scheme utilizing a communication network (e.g., a mobile communication network, wired Internet, wireless Internet, a broadcasting network, a satellite network, etc.) that may be included in a network, but also a short-range wireless communication method between devices. For example, the network may include any one or more from among a personal area network (PAN), a local area network (LAN), a campus area network (CAN), a metropolitan area network (MAN), a wide area network (WAN), a broadband network (BBN), or the Internet. In addition, the network may include any one or more from among network topologies including a bus network, a star network, a ring network, a mesh network, a star-bus network, and a tree or hierarchical network, but example embodiments are not limited thereto.

In addition, although the ERP image is illustrated as being generated using the omnidirectional monocular camera 1, the ERP image may also be generated using a panorama mode of a general camera, depending on example embodiments.

Meanwhile, depending on example embodiments, there may be a case in which a three-dimensional model of an indoor space is to be generated from an ERP image of the indoor space captured by the omnidirectional monocular camera 1. In order to perform three-dimensional modeling based on the ERP image, it is desired to estimate the depth or normal in the ERP image. However, ERP images have more distortion compared to general perspective images, and thus it may be difficult to obtain an accurate depth or normal estimation result using a general depth estimation model based on perspective images.

In addition, the indoor space may include mirrors or glass. Because the three-dimensional mesh generator is unable to distinguish between mirrors or glass (e.g., unable to identify mirrors or glass) in the ERP image, a depth map and a normal map may be generated by reflecting the shapes appearing on the mirrors or glass. That is, a depth map and a normal map regarding a non-existent space (e.g., a depth map and a normal map corresponding to a space that does not actually exist) may be generated, and this may cause an incorrect three-dimensional mesh to be generated.

Moreover, the three-dimensional mesh generator may further include a mesh generation model for generating a three-dimensional mesh. The mesh generation model may be trained to generate a three-dimensional mesh using a loss function that includes a depth loss and a normal loss corresponding to the difference between the depth map and the normal map of the generated three-dimensional mesh and the depth map and the normal map of the ERP image. The performance of the three-dimensional mesh generated by the mesh generation model may vary depending on the respective hyperparameters configured for the depth loss and the normal loss. That is, when training the mesh generation model, each hyperparameter may be configured according to the characteristics of each ERP image. However, it may be difficult to determine suitable hyperparameters for each ERP image.

Accordingly, a three-dimensional mesh generator according to an example embodiment of the disclosure may convert an ERP image into a perspective image, generate a depth map and a normal map corresponding to the perspective image, and then generate a three-dimensional mesh based on the depth map and the normal map. In addition, by preprocessing the ERP image or the perspective image, an area corresponding to a specific material such as a mirror region or glass region, may be removed using an inpainting technique before generating the three-dimensional mesh, thereby reducing or preventing generation of an erroneous space in the three-dimensional mesh. In relation to hyperparameters, the three-dimensional mesh generator according to an example embodiment of the disclosure may be trained while scheduling the respective hyperparameters, thereby making it possible to train a mesh generation model capable of generating a higher-performance three-dimensional mesh without separately searching for optimized hyperparameters.

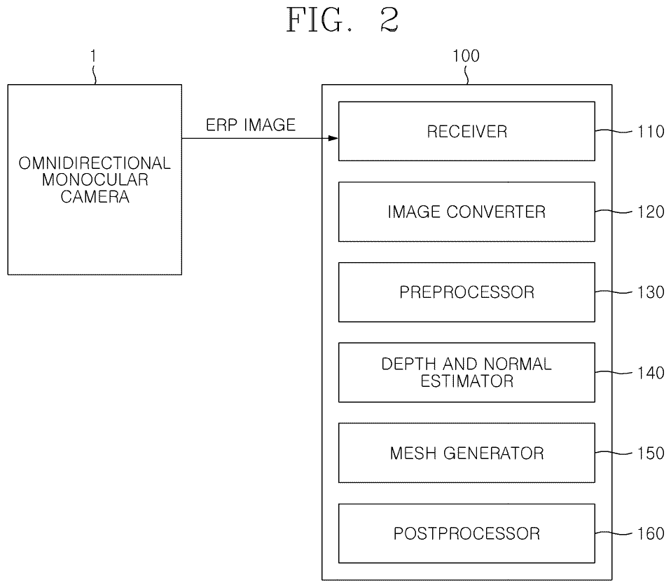

Hereinafter, a three-dimensional mesh generator according to an example embodiment of the disclosure will be described with reference to FIG. 2.

FIG. 2 is a schematic diagram illustrating a three-dimensional mesh generator according to an example embodiment of the disclosure.

Referring to FIG. 2, the three-dimensional mesh generator 100 according to an example embodiment of the disclosure may include a receiver 110, an image converter 120, a preprocessor 130, a depth and normal estimator 140, a mesh generator 150, and a postprocessor 160.

The receiver 110 may receive the ERP image through a wired/wireless communication network. That is, the receiver 110 may directly receive the ERP image from an omnidirectional monocular camera 1 that generates ERP images or from the user's terminal device, and in some example embodiments, it is also possible to receive the ERP image through a separate server or storage device that stores ERP images generated by the omnidirectional monocular camera.

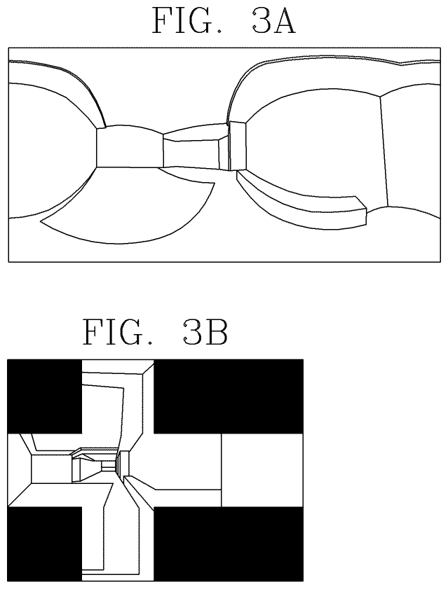

The image converter 120 may convert the ERP image regarding the target environment to generate a plurality of perspective images. That is, as shown in FIG. 3A, an ERP image in a spherical domain may be input, and the image converter 120 may convert the ERP image into a cubemap image in a corresponding cubemap domain, as shown in FIG. 3B. Referring to FIG. 3B, the cubemap image may be generated so as to correspond to the net diagram of a rectangular parallelepiped, and the front, back, left, right, top, and bottom surfaces corresponding to the target environment T may be displayed in perspective view types, respectively. That is, the areas corresponding to the front, back, left, right, top, and bottom surfaces in the ERP image may be distinguished, and the areas may be converted into perspective views, thereby generating a cubemap image. The image converter 120 may generate a cubemap image by utilizing various algorithms that convert an ERP image into a cubemap image. Thereafter, the image converter 120 may divide the 6 perspective images corresponding to the 6 surfaces included in the cubemap image, thereby generating perspective images. That is, the six perspective images corresponding to the front, back, left, right, top, and bottom surfaces, respectively, may be divided to generate the same. The term “cubemap” refers to a method of representing a 360-degree environment using the six faces of a cube.

If there is a perspective image including a specific material area among the plurality of perspective images, the preprocessor 130 may remove the specific material area using an inpainting technique, which is a digital restoration technique used to fill in damaged or unwanted parts of an image. The specific material area may include a transmissive or reflective surface, such as a mirror, glass, or a metal surface. However, example embodiments of the disclosure are not limited thereto, and the user may also define a certain area as a specific material area and use the same, depending on example embodiments. In addition, although the preprocessor 130 is shown as removing a specific material area included in the perspective image, the preprocessor 130 may remove the specific material area from the ERP image in advance, depending on example embodiments.

The preprocessor 130 may regenerate the pixel values of the specific material area using the inpainting technique, and the preprocessor 130 may regenerate the specific material area so as to appear to have the same material as an area adjacent thereto. The specific material area reflects or projects light, thereby appearing to have another space inside. Therefore, it is desired to remove the characteristics of the specific material area (e.g., reflecting or projecting light) before estimating the depth map or normal map, based on the perspective image. Therefore, the preprocessor 130 may redraw the specific material area with the same material as the area adjacent to the specific material area. For example, if a mirror is included in one of the wall surfaces of the indoor space, the mirror may be redrawn using the material of the wallpaper appearing next to the mirror, thereby removing the reflected area inside the mirror. That is, in order to reduce or prevent the normal from being estimated differently by the pixel values in the specific material area newly generated through inpainting, the preprocessor 130 may perform inpainting so that the specific material area is recognized as a flat plane.

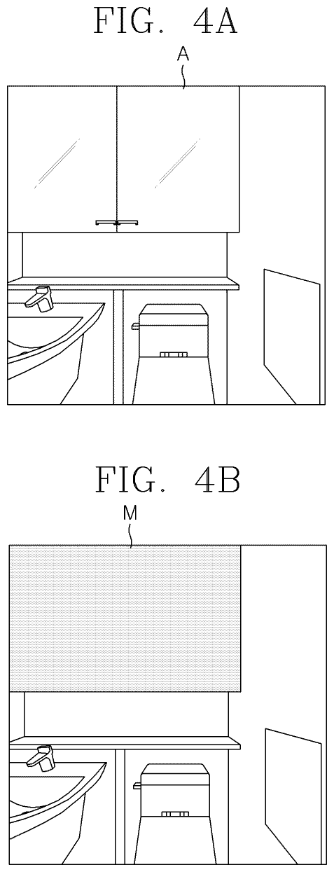

First, the preprocessor 130 may receive a masking image including a masking area obtained by masking a specific material area in the perspective image. Referring to FIG. 4A, a mirror A may be included in the perspective image. Because the opposite space may be reflected and displayed in the mirror A, the mirror A corresponds to a specific material area. Therefore, as shown in FIG. 4B, a masking image including a masking area M that masks the mirror A may be generated.

The masking image may be generated inside the preprocessing unit 130. That is, the preprocessor 130 may apply a segmentation or object recognition technique to each perspective image or ERP image to recognize a specific material area and automatically mask the recognized specific material area, thereby generating a masking image.

In addition, depending on example embodiments, the worker or the like may visually identify a specific material area, such as a mirror or glass, included in the perspective image or the ERP image and mask the specific material area, thereby generating a masking image. That is, because it may be difficult to automatically recognize mirrors or glass included in the perspective image or ERP image through image processing, it is also possible to request the worker or the like to conduct masking and then receive and process respective masking images.

Upon receiving a masking image, the preprocessor 130 may inpaint the inside of the masking area, based on the pixel values of adjacent pixels located in an adjacent area adjacent to the masking area. That is, in order to perform inpainting with the same material as the material of the adjacent area, the pixel values of adjacent pixels may be identified, and inpainting may be performed using the pixel values of the adjacent pixels.

For example, the preprocessor 130 may extract pixel values of adjacent pixels that are horizontally adjacent to the masking area, among adjacent pixels, and may reconfigure pixel values in the masking area to the interpolation values generated by interpolating the pixel values of the adjacent pixels. The indoor space may be divided into a ceiling surface, a floor surface, and side surfaces. In general, mirrors or glass are located on side surfaces in the indoor space, and the preprocessor 130 may thus perform inpainting, based on the pixel values of respective adjacent pixels that are horizontally adjacent to respective specific material areas. This makes it possible to distinguish the inpainted specific material area from the ceiling or floor surface, while it is difficult to distinguish the inpainted specific material area from the side surface where the specific material area is located.

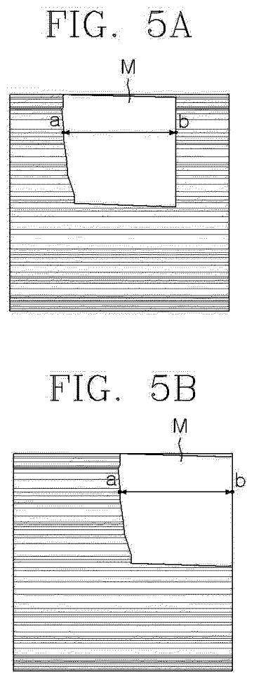

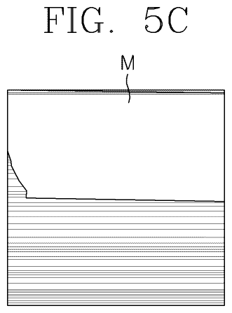

Referring to FIGS. 5A, 5B, and 5C, adjacent areas may exist on the left and right of the masking area M in the masking image as shown in FIG. 5A. In this case, linear interpolation may be performed using respective pixel values on the left and right sides of the masking area M to generate an interpolation value, and the interpolation value may be used to fill respective pixel values within the masking area M. That is, respective pixels included in the masking area M in FIG. 5A may be divided into rows, and inpainting may be performed with regard to each row. For example, with regard to each row included in the masking area M, respective adjacent pixels (a, b) that are adjacent to the left and right sides of the row may be specified. Thereafter, the pixel value of the corresponding adjacent pixel (a, b) may be linearly interpolated to generate an interpolation value, and the interpolation value may be reconfigured as the pixel value regarding the entire pixels included in the corresponding row in the masking area M. In the same manner, the pixel values of all rows included in the masking area M may be reconfigured to inpaint the masking area M.

In addition, as shown in FIG. 5B, an adjacent area may exist only on one side of the left and right side of the masking area M. In this case, with regard to respective rows included in the masking area M, respective adjacent pixels a included in the left adjacent area may be specified, and the pixel values of all pixels in the corresponding row in the masking area M may be reconfigured to the pixel value of the corresponding adjacent pixel a. In the same manner, pixel values of all rows included in the masking area M may be reconfigured to inpaint the masking area M.

Meanwhile, as shown in FIG. 5C, no adjacent area that is horizontally adjacent to the masking area M may exist. In this case, with regard to respective rows included in the masking area M, the pixel values may be reconfigured to a desired (or alternatively, predetermined) single color. For example, the pixel value of the corresponding pixel may be configured to (r, g, b)=(128, 128, 128) and inpainted.

After the preprocessing is completed, the depth and normal estimation unit 140 may generate a depth map and a normal map corresponding to the ERP image using a plurality of perspective images. The depth and normal estimation unit 140 may include a depth estimation model for generating each depth map and a normal estimation model for generating a normal map.

The depth and normal estimation unit 140 may generate respective depth maps corresponding to a plurality of perspective images using the depth estimation model. The depth estimation model is trained to configure depth values corresponding to respective pixels in a perspective image that has been input, and may be implemented in various types, such as a deep learning model or a neural network model. The depth and normal estimation unit 140 may utilize various types of depth estimation models depending on example embodiments, and any type of depth estimation model may be utilized as long as the same configures a depth value regarding a perspective image that is input and generates a depth map corresponding to the perspective image.

In addition, the depth and normal estimation unit 140 may generate respective normal maps corresponding to a plurality of perspective view images using a normal estimation model. In order to generate a corresponding three-dimensional mesh from an ERP image, a normal map is also desired in addition to a depth map. Therefore, it is also possible to further include a normal estimation model to generate a normal map as well as a depth map. The normal estimation model generates a normal map representing normal information regarding respective planes included in a plurality of perspective images that have been input, and may be implemented in various types, based on a deep learning model or a neural network model. That is, any type of normal estimation model may be utilized as long as the same can configure a normal vector regarding a perspective image that is input and generate a normal map corresponding to the perspective image.

Depending on example embodiments, the depth and normal estimation unit 140 may convert respective depth maps and normal maps into a spherical domain corresponding to the ERP image, thereby generating an ERP depth map and an ERP normal map, respectively. That is, depth maps and normal maps generated in the cubemap domain may be combined and again converted into the spherical domain, thereby generating an ERP depth map and an ERP normal map. The depth and normal estimation unit 140 may parameterize depth maps and normal maps, and may update depth values of depth maps and normal vectors of normal maps, thereby maintaining consistency between respective depth maps and normal maps and matching the scale. Thereafter, an ERP depth map and an ERP normal map may be generated through conversion based on the updated depth maps and normal maps.

The mesh generator 150 may generate a three-dimensional mesh corresponding to a depth map and a normal map using a mesh generation model. That is, the mesh generator 150 may input a plurality of depth maps and normal maps corresponding to respective perspective images into a mesh generation model to generate a three-dimensional mesh corresponding to the ERP image. However, depending on example embodiments, it is also possible to input each ERP depth map and ERP normal map to a mesh generation model to generate a three-dimensional mesh.

The mesh generation model may generate a three-dimensional mesh, based on neural rendering, such as mono-signed distance function (SDF). The mesh generation model may be trained based on a loss function including a depth loss and a normal loss, which are the differences between the depth map and the normal map in the generated three-dimensional mesh and the depth map and the normal map generated from the ERP image. For example, a loss function for training a mesh generation model may be configured as follows.

L=L_{rgb}+λ₁Lₑᵢₖₒₙₐₗ+λ₂L_{depth}+λ₃Lₙₒᵣₘₐₗ

wherein L_{rgb} refers to a color loss, Lₑᵢₖₒₙₐₗ refers to an eikonal loss, L_{depth} refers to a depth loss, Lₙₒᵣₘₐₗ refers to a normal loss, λ₁ refers to an eikonal weight, λ₂ refers to a depth weight, and λ₃ refers to a normal weight. λ₁, λ₂, and λ₃ are hyperparameters used for training a mesh generation model.

That is, the loss function for training the mesh generation model may include a depth loss and a normal loss, and a depth weight and a normal weight may be applied to the depth loss and the normal loss, respectively. If fixed hyperparameters are used, optimal hyperparameters need to be configured according to the characteristics of respective pieces of data during training. For example, if the normal weight is configured to be higher than the depth weight, training is performed with more focus on the normal than the depth, so respective distances in the generated three-dimensional mesh may be different, but respective planes may be generated flat. That is, in the case of a thin wall, the plane of the thin wall is well represented as a flat surface in the three-dimensional mesh, but the thickness may be represented too thick, or the same may be generated as two different planes.

In addition, if the depth weight is set higher than the normal weight, training is performed with more focus on the depth, so respective distances in the three-dimensional mesh may be matched, but there may be a problem in that respective planes are not generated flat. That is, in the case of a thin wall, the distance between the thin wall and another wall may be well represented, but problems such as the generation of holes in the thin wall may occur.

Therefore, the mesh generator 150 may train the mesh generation model while changing respective weights applied to the depth loss and the normal loss according to scheduling. That is, scheduling may be configured such that the depth weight applied to the depth loss is reduced from the initial depth weight with regard to each epoch so as to reach the target depth weight, and the normal weight applied to the normal loss is increased from the initial normal weight with regard to each epoch so as to reach the target normal weight. The initial depth weight may be configured greater than the initial normal weight, and the target depth weight may be configured smaller than the target normal weight. For example, in the case of the depth weight, the initial depth weight may be 0.20, the target depth weight may be 0.14, and the depth weight may be configured to decrease by 0.01 every 20 epochs. In the case of the normal weight, the initial normal weight may be 0.02, the target normal weight may be 0.14, and the normal weight may be configured to increase by 0.02 every 20 epochs.

In this case, in an initial stage, the depth weight may be set to be greater than the normal weight, so that the structures, such as walls, in the three-dimensional mesh may be generated with an approximate spatial structure corresponding to depth information. In the course of training, the depth weight may be decreased, and the normal weight may be increased such that noise on planar surfaces of the structures, such as walls, in the three-dimensional mesh may be gradually reduced to generate structures having flatter planar surfaces.

That is, the mesh generation model may be trained such that, rather than using fixed hyperparameter values, the hyperparameters are changed for each epoch during the training, thereby generating a three-dimensional mesh with reduced surface noise and improve planar surface quality without separately searching for optimized hyperparameters.

Meanwhile, a three-dimensional mesh generated by the mesh generation model may generally provide information about the relative distance, ratio, or the like between internal points, but may not provide information about the actual distance or the like between the points. That is, the ERP image or the like does not include information about the actual distance or the like, and thus the three-dimensional mesh alone may not provide information about the actual distance.

Accordingly, the mesh generator 150 may train the mesh generation model such that the depth loss includes additional items so as to reflect the actual distance value in the three-dimensional mesh. That is, if the target environment T is an indoor space, an additional item corresponding to the difference between the depth value of the center point in the depth map of the three-dimensional mesh and the camera height value of the camera that captured the ERP image may be added to the depth loss during training. The mesh generation unit 150 may reflect the additional item during training with regard to only the perspective image corresponding to the floor surface of the target environment, among a plurality of perspective images.

In the case of an ERP image generated by the omnidirectional monocular camera 1, the depth value of the central point on the floor surface corresponds to the camera height of the omnidirectional monocular camera 1. Therefore, if the loss function is configured such that the depth value of the center point of the floor surface approaches the actual camera height, the depth value of the center point of the floor surface in the generated three-dimensional mesh may be represented as the actual camera height value. In this case, the remaining depth values in the three-dimensional mesh also correspond to the actual distance values, and it is thus possible to generate a three-dimensional mesh reflecting a metric scale capable of measuring the distance or the like of the actual target environment.

If the target environment is an indoor space, the postprocessing unit 160 may detect a plane included in the three-dimensional mesh and perform postprocessing to simplify the planes and remove noise. For example, the postprocessing unit 160 may first convert a three-dimensional mesh into a point cloud and then distinguish each plane included in the point cloud using a segmentation technique such as random sample consensus (RANSAC).

Thereafter, the ceiling surface and the floor surface may be distinguished, based on the normal direction of each plane. For example, a predefined (or reference) vertical direction and the normal direction of respective planes may be compared to find candidate planes that match with the predefined (or reference) vertical direction within an error range. Among the candidate planes, candidate planes that include the largest number of points on the upper side and lower side, respectively, based on the center of the entire coordinate system, may be identified and configured as the ceiling surface and the floor surface, respectively.

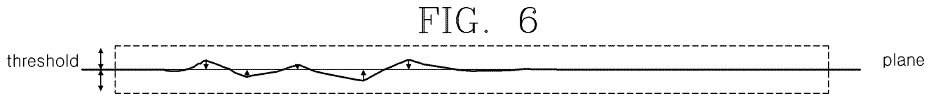

In addition, points located within a configured range (e.g., a threshold range) in the normal direction of the ceiling surface and the floor surface may be projected onto the corresponding ceiling surface or floor surface, and then included in the ceiling surface or the floor surface. That is, as shown in FIG. 6, respective points located within the configured range (threshold) in the normal direction of each ceiling or floor surface may be found, and respective points may be projected onto a plane. Noise located around the ceiling or floor surface may thereby be organized and simplified into the ceiling or floor surface.

Thereafter, the postprocessing unit 160 may configure the remaining points other than the ceiling and floor surfaces as side surfaces, based on respective normals thereof. For example, points having a normal perpendicular to the normal vector of the ceiling or floor surface may be clustered, and other points adjacent to the points may be further included and clustered based on each normal direction. Respective clustered surfaces may be divided into respective side surfaces. That is, points having normals perpendicular to the normal vector of the ceiling or floor surface correspond to side surfaces of the indoor space, and may thus be clustered.

Meanwhile, the Manhattan-world assumption means that respective surfaces in an indoor space are generated to be perpendicular to each other. In the case where the Manhattan-world assumption is applied, if the normal direction of the ceiling or floor surface is configured as the z-axis in a Cartesian coordinate system, the remaining side surfaces may be defined as having normal directions corresponding to the x-axis and y-axis, respectively. Therefore, points having normal directions corresponding to the x-axis and y-axis, respectively, may be clustered and distinguished as side surfaces.

On the other hand, if the Manhattan-world assumption is not applied, side surfaces may be perpendicular to the normal of the ceiling and floor surfaces, but the side surfaces may not form right angles with each other. Therefore, side surfaces may be distinguished by clustering points that have a normal perpendicular to the normal vector of the ceiling or floor surface.

Thereafter, with regard to side surfaces as well, points located within a configured range (e.g., a threshold range) in the normal direction of each of respective side surfaces may be projected onto the corresponding one of the respective side surfaces and included in the respective side surfaces, respectively.

Finally, after the ceiling, floor, and side surfaces are distinguished, tangent lines at which respective ceiling, floor, and side walls meet may be detected, and it may be confirmed whether there are areas that exceed the tangent lines. If there are areas that exceed the tangent lines, the areas may be projected onto the inside of the tangent lines and removed, respectively. That is, the ERP image is obtained by capturing an indoor space, and if the Manhattan-world assumption is satisfied, the ceiling, floor, and side surfaces may be combined to generate a cuboid shape. The areas exceeding the tangent lines may be considered as error areas, because they correspond to areas protruding from the cuboid. Therefore, it is possible to simplify and generate the entire three-dimensional mesh by projecting and removing the deviated areas on each plane.

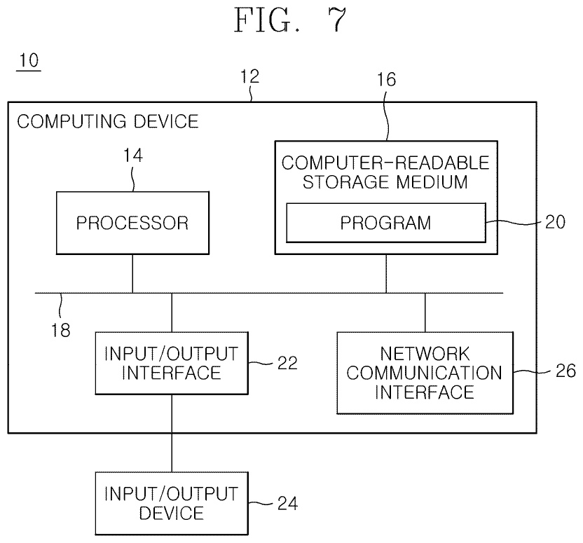

FIG. 7 is a block diagram illustrating a computing environment 10 suitable for use according to an example embodiment. In the illustrated example embodiment, each component may have different functions and capabilities other than those described below, and may further include additional components other than those described below.

The illustrated computing environment 10 includes a computing device 12. In an example embodiment, the computing device 12 may be a device for generating a three-dimensional mesh based on an ERP image (e.g., a three-dimensional mesh generator 100).

The computing device 12 includes at least one processor 14, a computer-readable storage medium 16, and a communication bus 18. The processor 14 may cause the computing device 12 to perform one or more operations described above. For example, the processor 14 may execute one or more programs stored in the computer-readable storage medium 16. The one or more programs may include one or more computer-executable instructions, and the computer-executable instructions may be configured to, when executed by the processor 14, cause the computing device 12 to perform operations according to one of more example embodiments.

The computer-readable storage medium 16 is configured to store computer-executable instructions or program code, program data, and/or other suitable forms of information. The program 20 stored in the computer-readable storage medium 16 includes a set of instructions executable by the processor 14. In an example embodiment, the computer-readable storage medium 16 may be a memory (a volatile memory such as a random access memory, a non-volatile memory, or a suitable combination thereof), one or more magnetic disk storage devices, optical disk storage devices, flash memory devices, other types of storage media capable of being accessed by the computing device 12 and storing desired information, or a suitable combination thereof.

The communication bus 18 interconnects various components of the computing device 12, including the processor 14 and the computer-readable storage medium 16.

The computing device 12 may also include one or more input/output interfaces 22 that provide interfaces for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. Some examples of the input/output device 24 may include an input device, such as a pointing device (e.g., a mouse or a trackpad), a keyboard, a touch input device (e.g., a touchpad or a touchscreen), a voice or sound input device, various types of sensor devices, and/or image capturing devices, and/or an output device, such as a display device, a printer, a speaker, and/or a network card. According to some example embodiments, the input/output device 24 may be included inside the computing device 12 as a component that constitutes the computing device 12, or may be a separate device distinct from the computing device 12 and connected to the computing device 12.

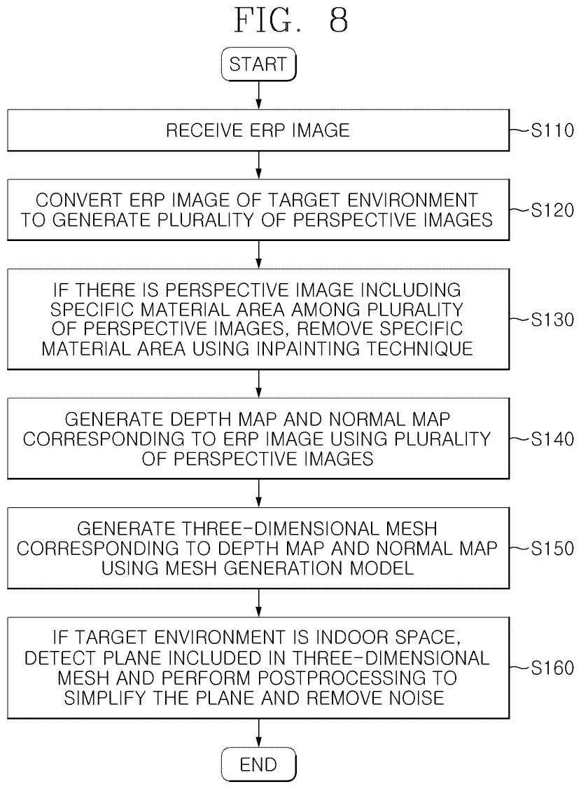

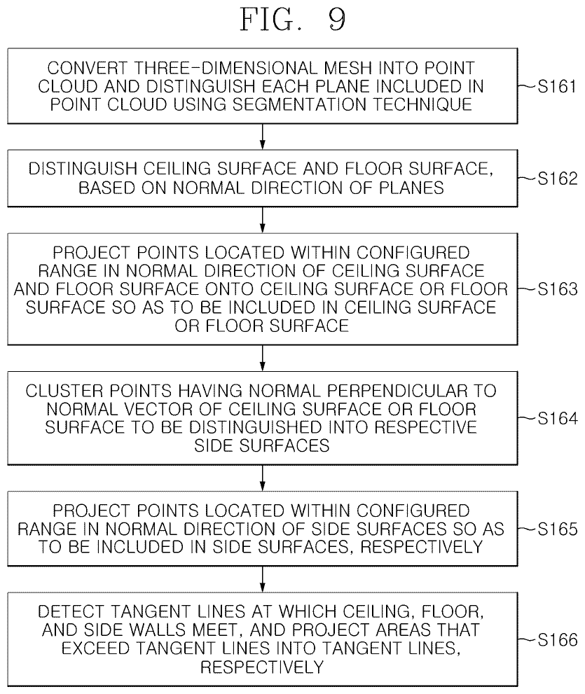

FIG. 8 and FIG. 9 are flowcharts illustrating an ERP image-based three-dimensional mesh generation method according to an example embodiment of the disclosure. Respective steps of FIG. 8 and FIG. 9 may be performed by a computing device according to an example embodiment of the disclosure.

Referring to FIG. 8, the computing device may receive an ERP image of a target environment (S110). That is, the computing device may directly receive the ERP image from an omnidirectional monocular camera that generates ERP images or from the user's terminal device through a wired/wireless communication network, or may receive the ERP image through a separate server or storage device that stores ERP images.

Thereafter, the computing device may convert the ERP image of the target environment to generate a plurality of perspective images (S120). That is, if an ERP image in a spherical domain is input, the computing device may convert the ERP image and generate a cubemap image in a corresponding cubemap domain. The cubemap image may be generated to correspond to the net diagram of a rectangular parallelepiped, and respective front, back, left, right, top, and bottom surfaces corresponding to the target environment may be displayed in the perspective type. In addition, the computing device may divide six perspective images corresponding to the six surfaces included in the cubemap image to generate a perspective image. That is, six perspective view images corresponding to the front, back, left, right, top, and bottom surfaces may be divided to generate the same.

If there is a perspective image including a specific material area among the plurality of perspective images, the computing device may remove the specific material area using an inpainting technique (S130). The specific material area may include a transmissive or reflective surface, such as a mirror, glass, or a metal surface.

The computing device may reconfigure the specific material area through an inpainting technique, and may regenerate the specific material area so as to appear to have the same material as adjacent areas. The specific material area reflects or projects light, thereby appearing to have other spaces inside. Therefore, it is desired to remove the characteristics of the specific material area (e.g., reflecting or projecting light) before estimating the depth map or normal map, based on the perspective image. Therefore, the computing device may draw the specific material area with the same material as adjacent areas of the specific material area.

For example, the computing device may receive a masking image including a masking area obtained by masking a specific material area in the perspective image. The masking image may be generated inside the preprocessor 130, and in some example embodiments, it is also possible to receive a masking image generated by the worker or the like from the outside.

Upon receiving a masking image, the computing device may inpaint the inside of the masking area, based on the pixel values of adjacent pixels located in an adjacent area adjacent to the masking area. Depending on example embodiments, the computing device may extract pixel values of adjacent pixels that are horizontally adjacent to the masking area, among adjacent pixels, and may reconfigure pixel values in the masking area to the interpolation values generated by interpolating the extracted pixel values of the adjacent pixels. The computing device may thus perform inpainting, based on the extracted pixel values of respective adjacent pixels that are horizontally adjacent, thereby making it possible to distinguish the inpainted specific material area from the ceiling or floor surface, while it is difficult to distinguish the same from the side surface where the specific material area is located.

Thereafter, the computing device may generate a depth map and a normal map corresponding to the ERP image using a plurality of perspective images (S140). The computing device may generate the depth map and the normal map by utilizing a depth estimation model for generating each depth map and a normal estimation model for generating a normal map. The depth estimation model and the normal estimation model may be implemented in various manners, such as a deep learning model or a neural network model, and any type may be utilized as long as it configures a depth value and a normal vector regarding an input perspective image and generates a depth map and a normal map corresponding thereto.

Depending on example embodiments, the computing device may convert respective depth maps and normal maps into a spherical domain corresponding to the ERP image, thereby generating an ERP depth map and an ERP normal map, respectively. That is, depth maps and normal maps generated in the cubemap domain may be combined and again converted into the spherical domain, thereby generating an ERP depth map and an ERP normal map. The computing device may parameterize depth maps and normal maps, and may update depth values of depth maps and normal vectors of normal maps, thereby maintaining consistency between respective depth maps and normal maps and matching the scale. Thereafter, an ERP depth map and an ERP normal map may be generated through conversion based on the updated depth maps and normal maps.

The computing device may generate a three-dimensional mesh corresponding to a depth map and a normal map using a mesh generation model (S150). That is, the computing device may input a plurality of depth maps and normal maps corresponding to each perspective image into a mesh generation model to generate a three-dimensional mesh corresponding to the ERP image. However, depending on example embodiments, it is also possible to input each ERP depth map and ERP normal map into a mesh generation model to generate a three-dimensional mesh.

The mesh generation model may generate a three-dimensional mesh, based on neural rendering, such as a mono-signed distance function (SDF). The mesh generation model may be trained based on a loss function including a depth loss and a normal loss, which are the differences between the depth map and the normal map in the generated three-dimensional mesh and the depth map and the normal map generated from the ERP image.

If fixed hyperparameters are used, optimal hyperparameters need to be configured depending on the characteristics of respective pieces of data during training. However, it is not easy to find and configure optimal hyperparameters each time, so it may be difficult to implement a mesh generation model that produces a higher-performance three-dimensional mesh.

However, the computing device may train the mesh generation model while changing respective weights applied to the depth loss and the normal loss according to scheduling. That is, scheduling may be configured such that the depth weight applied to the depth loss is reduced from the initial depth weight with regard to each epoch so as to reach the target depth weight, and the normal weight applied to the normal loss is increased from the initial normal weight with regard to each epoch so as to reach the target normal weight. The initial depth weight may be configured to be greater than the initial normal weight, and the target depth weight may be configured to be smaller than the target normal weight.

In this case, the depth weight is relatively high and the normal weight is relatively low in the initial stage, so that the structures such as walls in the three-dimensional mesh may be generated to some extent to match the distance. In the course of training, the depth weight is decreased, and the normal weight is increased such that noise of the planes of the structures such as walls in the three-dimensional mesh may be gradually removed to generate flat structures.

That is, the mesh generation model may be trained such that, rather than using fixed hyperparameters values, the hyperparameters are changed for each epoch during the training, thereby generating a higher-performance three-dimensional mesh without separately searching for optimized hyperparameters.

Additionally, a three-dimensional mesh generated by the mesh generation model may provide information about the relative distance, ratio, or the like between internal points, but may not provide information about the actual distance or the like between the points.

Accordingly, the computing device may train the mesh generation model such that the depth loss includes additional items so as to reflect the actual distance value in the three-dimensional mesh. That is, if the target environment is an indoor space, an additional item corresponding to the difference between the depth value of the center point in the depth map of the three-dimensional mesh and the camera height value of the camera that captured the ERP image may be added to the depth loss during training. The computing device may reflect the additional item during training with regard to only the perspective image corresponding to the floor surface of the target environment, among a plurality of perspective images.

In the case of an ERP image generated by an omnidirectional monocular camera, the depth value of the central point on the floor surface corresponds to the camera height of the omnidirectional monocular camera. Therefore, if the loss function is configured such that the depth value of the center point of the floor surface approaches the actual camera height, the depth value of the center point of the floor surface in the generated three-dimensional mesh may match with the actual camera height value. Therefore, the remaining depth values in the three-dimensional mesh also correspond to the actual distance values, and it is thus possible to generate a three-dimensional mesh reflecting a metric scale capable of measuring the distance or the like of the actual target environment.

If the target environment is an indoor space, the computing device may detect a plane included in the three-dimensional mesh and perform postprocessing to simplify the planes and remove noise (S160). For example, referring to FIG. 9, the computing device may first convert a three-dimensional mesh into a point cloud and then distinguish each plane included in the point cloud using a segmentation technique such as RANSAC (S161).

Thereafter, the ceiling surface and the floor surface may be distinguished, based on the normal direction of each plane (S162). For example, a predefined (or reference) vertical direction and the normal direction of respective planes may be compared to find candidate planes that match with the predefined (or reference) vertical direction within an error range. Among the candidate planes, candidate planes that include the largest number of points on the upper side and lower side, respectively, based on the center of the entire coordinate system, may be identified and configured as the ceiling surface and the floor surface, respectively.

Points located within a configured range in the normal direction of the ceiling surface and the floor surface may be projected onto the corresponding ceiling surface or floor surface, and then included in the ceiling surface or the floor surface (S163). Accordingly, noise located around the ceiling or floor surface may thereby be organized and simplified into the ceiling or floor surface.

Thereafter, the computing device may configure the remaining points, other than the ceiling and floor surfaces, as side surfaces, based on their respective normals. For example, points having a normal perpendicular to the normal vector of the ceiling or floor surface may be clustered, and other points adjacent to the points may be further included and clustered based on each normal direction. The respective clustered surfaces may be divided into respective side surfaces (S164). That is, points having normals perpendicular to the normal vector of the ceiling or floor surface correspond to side surfaces of the indoor space, and may thus be clustered.

Meanwhile, the Manhattan-world assumption means that respective surfaces in an indoor space are generated to be perpendicular to each other. In the case where the Manhattan-world assumption is applied, if the normal direction of the ceiling or floor surface is configured as the z-axis in a Cartesian coordinate system, the remaining side surfaces may be defined as having normal directions corresponding to the x-axis and y-axis, respectively. Therefore, points having normal directions corresponding to the x-axis and y-axis, respectively, may be clustered and distinguished as side surfaces.

On the other hand, if the Manhattan-world assumption is not applied, side surfaces may be perpendicular to the normal of the ceiling and floor surfaces, but the side surfaces may not form right angles with each other. Therefore, side surfaces may be distinguished by clustering points that have a normal perpendicular to the normal vector of the ceiling or floor surface.

Thereafter, with regard to side surfaces as well, points located within a configured range in the normal direction of respective side surfaces may be projected onto the corresponding side surfaces and included in the side surfaces, respectively (S165).

Finally, after the ceiling, floor, and side surfaces are distinguished, the computing device may detect tangent lines at which respective ceiling, floor, and side walls meet, and may confirm whether there are areas that exceed the tangent lines. If there are areas that exceed the tangent lines, the areas may be projected onto the inside of the tangent lines and removed, respectively (S166). That is, the ERP image is obtained by capturing an indoor space, and if the Manhattan-world assumption is satisfied, the ceiling, floor, and side surfaces may be combined to generate a cuboid shape. The areas exceeding the tangent lines may be considered as error areas, because they correspond to areas protruding from the cuboid. Therefore, it is possible to simplify and generate the entire three-dimensional mesh by projecting and removing the deviated areas on each plane.

The disclosure described above may be implemented as a computer-readable code on a medium on which a program is recorded. The computer-readable medium may be a medium that continuously stores a computer-executable program or temporarily stores it for execution or download. In addition, the medium may be a various recording means or storage means to which a single or multiple pieces of hardware are coupled, and is not limited to a medium directly connected to a computer system, but may be distributed on a network. Examples of the medium include magnetic media such as hard disks, floppy disks, and magnetic tapes, optical recording media such as CD-ROMs and DVDs, magneto-optical media such as floptical disks, and ROMs, RAMs, and flash memories, configured to store program instructions. In addition, other examples of the medium may include a recording medium or a storage medium managed by an app store that distributes applications or a site or a server that supplies or distributes various software. Therefore, the detailed description should not be construed as restrictive in all aspects and should be considered as examples. The scope of the disclosure should be determined by a reasonable interpretation of the appended claims, and all changes within the equivalent scope of the disclosure are included in the scope of the disclosure.

Any functional blocks shown in the figures and described above may be implemented in processing circuitry such as hardware including logic circuits, a hardware/software combination such as a processor executing software, or a combination thereof. For example, the processing circuitry may more specifically include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, an application-specific integrated circuit (ASIC), etc.

The disclosure is not limited to the example embodiments described above and the accompanying drawings. It will be apparent to those skilled in the art to which the disclosure pertains that components according to the disclosure may be substituted, modified, and changed without departing from the technical idea of the disclosure.

What is claimed is:

1. A method for generating a three-dimensional mesh based on an equirectangular projection (ERP) image using a computing device, the method comprising:
generating a plurality of perspective images by converting an ERP image of a target environment;
removing a specific material area from a perspective image using an inpainting technique, if the perspective image including the specific material area exists among the plurality of perspective images;
generating a depth map and a normal map corresponding to the ERP image using the plurality of perspective images; and
generating a three-dimensional mesh corresponding to the depth map and the normal map using a mesh generation model.

2. The method of claim 1, wherein the specific material area includes a transmissive or reflective surface.

3. The method of claim 1, wherein the removing includes regenerating the specific material area with a same material as an adjacent area of the specific material area, using the inpainting technique.

4. The method of claim 1, wherein the removing comprises:
receiving a masking image including a masking area obtained by masking the specific material area within the perspective image; and
inpainting an inside of the masking area, based on pixel values of adjacent pixels, the adjacent pixels being in an adjacent area that is adjacent to the masking area.

5. The method of claim 4, wherein the inpainting comprises:
interpolating pixel values of adjacent pixels that are horizontally adjacent to the masking area, to generate an interpolation value; and
reconfiguring pixel values in the masking area with the interpolation value.

6. The method of claim 4, further comprising:
generating the mesh generation model through training based on a loss function including a depth loss and a normal loss, the depth loss and the normal loss being differences between a depth map and a normal map of the three-dimensional mesh and a depth map and a normal map generated from the ERP image, respectively, and
changing respective weights applied to the depth loss and the normal loss during training according to scheduling.

7. The method of claim 6, wherein the scheduling is configured such that
a depth weight applied to the depth loss is decreased from an initial depth weight with regard to each epoch so as to reach a target depth weight, and
a normal weight applied to the normal loss is increased from an initial normal weight with regard to each epoch so as to reach a target normal weight.

8. The method of claim 7, wherein the initial depth weight is larger than the initial normal weight, and the target depth weight is smaller than the target normal weight.

9. The method of claim 6, further comprising:
training the mesh generation model such that, if the target environment is an indoor space, the depth loss further includes an additional item corresponding to a difference between a depth value of a center point in a depth map of the three-dimensional mesh and a camera height value of a camera used to capture the ERP image.

10. The method of claim 9, wherein the mesh generation model is trained such that the additional item is reflected with regard to a perspective image corresponding to a floor surface of the target environment, among the plurality of perspective images.

11. The method of claim 1, further comprising:
postprocessing performed such that, if the target environment is an indoor space, planes included in the three-dimensional mesh are detected, and the planes are simplified to remove noise.

12. The method of claim 11, wherein the postprocessing comprises:
converting the three-dimensional mesh into a point cloud, and distinguishing respective planes included in the point cloud using a segmentation technique;
distinguishing a ceiling surface and a floor surface, based on normal directions of the respective planes;
projecting first points located within a configured range in the normal directions of the ceiling surface and the floor surface, onto the ceiling surface or the floor surface, so as to be included in the ceiling surface or the floor surface;
clustering second points having a normal perpendicular to a normal vector of the ceiling surface or the floor surface, to distinguish side surfaces;
projecting third points located within a threshold range in a normal direction of each of the side surfaces onto a corresponding one of the side surfaces so as to be included in the side surfaces, respectively; and
detecting tangent lines at which the ceiling surface and the floor surface meet side walls, and projecting areas exceeding the tangent lines into the tangent lines, respectively.

13. The method of claim 12, wherein the clustering includes applying a Manhattan-world assumption to
configure a normal direction of the ceiling surface or floor surface i as a z-axis in a Cartesian coordinate system, and
cluster remaining points having normal directions corresponding to an x-axis and a y-axis to distinguish the side surfaces.

14. A computing device for generating a three-dimensional mesh based on an equirectangular projection (ERP) image, the computing device comprising a processor configured to:
generate a plurality of perspective images by converting an ERP image of a target environment;
remove a specific material area from a perspective image using an inpainting technique, if the perspective image including the specific material area exists among the plurality of perspective images;
generate a depth map and a normal map corresponding to the ERP image using the plurality of perspective images; and
generate a three-dimensional mesh corresponding to the depth map and the normal map using a mesh generation model.

15. The computing device of claim 14, wherein the processor is configured to remove the specific material area by regenerating the specific material area with a same material as an adjacent area of the specific material area, using the inpainting technique, the specific material area including a transmissive or reflective surface.

16. The computing device of claim 14, wherein the processor is configured to remove the specific material area by
receiving a masking image including a masking area obtained by masking the specific material area within the perspective image; and
inpainting an inside of the masking area, based on pixel values of adjacent pixels, the adjacent pixels being in an adjacent area that is adjacent to the masking area.

17. The computing device of claim 16, wherein the inpainting comprises:
interpolating the pixel values of the adjacent pixels that are horizontally adjacent to the masking area, to generate an interpolation value; and
reconfiguring pixel values in the masking area with the interpolation value.

18. The computing device of claim 16, wherein the processor is configured to
generate the mesh generation model through training based on a loss function including a depth loss and a normal loss, the depth loss and the normal loss being differences between a depth map and a normal map of the three-dimensional mesh and a depth map and a normal map generated from the ERP image, respectively, and
change respective weights applied to the depth loss and the normal loss during training according to scheduling.

19. The computing device of claim 18, wherein the processor is configured to generate the scheduling such that
a depth weight applied to the depth loss is decreased from an initial depth weight with regard to each epoch so as to reach a target depth weight, and
a normal weight applied to the normal loss is increased from an initial normal weight with regard to each epoch so as to reach a target normal weight.

20. A non-transitory computer-readable recording medium storing instructions thereon, which when executed by at least one processor, cause a computing device including the at least one processor to implement a method for generating a three-dimensional mesh based on an equirectangular projection (ERP) image, the method comprising:
generating a plurality of perspective images by converting an ERP image of a target environment;
removing a specific material area using an inpainting technique, if a perspective image including the specific material area exists among the plurality of perspective images;
generating a depth map and a normal map corresponding to the ERP image using the plurality of perspective images; and
generating a three-dimensional mesh corresponding to the depth map and the normal map using a mesh generation model.
